(19) United States
(12) Patent Application Publication
(10) Pub. No.: US 2016/0375668 A1
(43) Pub. Date: Dec. 29, 2016

(54) METHOD OF FORMING A COMPOSITE STRUCTURE

(71) Applicant: Sikorsky Aircraft Corporation, Stratford, CT (US)

(72) Inventors: Jonathan Bremmer, Glastonbury, CT (US); Robert A. Lacko, Oxford, CT (US); Jeffrey G. Sauer, Woodbury, CT (US); Darryl Mark Toni, Madison, CT (US)

(21) Appl. No.: 14/704,164

(22) Filed: May 5, 2015

Related U.S. Application Data
(60) Provisional application No. 62/022,348, filed on Jul. 9, 2014.

(51) Int. Cl. B32B 37/06; B32B 38/00

(52) U.S. Cl. CPC B32B 37/06; B32B 38/0012; B32B 2605/18; B32B 2250/40; B32B 2305/74

(57) ABSTRACT

A method of forming a sandwich composite structure by placing a core under a compressive force or a tensile force and applying a first layer to a first surface of the core. The core and first layer are then heated. The compressive or tensile force is then released, allowing the composite structure to take shape.

### CROSS-REFERENCE TO RELATED APPLICATIONS

This application claims the benefit of U.S. provisional patent application Ser. No. 62/022,348, filed Jul. 9, 2014, the entire contents of which are incorporated herein by reference.

### STATEMENT REGARDING FEDERALLY SPONSORED RESEARCH OR DEVELOPMENT

This invention was made with Government support with the United States Navy under Contract No. N00019-06-0081. The Government therefore has certain rights in this invention.

### BACKGROUND

The subject matter disclosed herein relates generally to the field of composite structures, and more particularly, to impact resistant composite structures and methods for making such composite structures.

Composite structures are manufactured for use in a variety of structural applications, particularly where the structures are required to possess high stiffness-to-weight and strength-to-weight ratios. For example, a honeycomb core sandwich structure has composite laminate skins that are co-cured with adhesives to opposite sides of a lightweight honeycomb core that can be formed of paper, metal, and the like. Such structures are useful, for example, in aircraft manufacturing, where such qualities are of primary importance.

The structure is usually formed by arranging the structure in layers on a mandrel or other tool. When the structure includes a thick core material that exhibits stiffness, such as a high-density honeycomb core, the core is typically heated to soften the core material prior to arranging it on the mandrel. Once the core material is placed on the mandrel and cooled, the core often exhibits local stresses at nodes as a result of the heating and shaping. This results in high failure rates and wasted material. Accordingly, the industry is receptive to improved methods for forming composite structures with thick core materials.

### SUMMARY

Disclosed herein is a method of forming a sandwich composite structure. This is done by placing a core under a compressive force or a tensile force and applying a first layer to a first surface of the core. The core and first layer are then heated. The compressive or tensile force is then released, allowing the composite structure to take shape.

In addition to one or more of the features described above, or as an alternative, in further embodiments, wherein placing the core under the compressive or tensile force is performed to reach a known dimension of the core.

In addition to one or more of the features described above, or as an alternative, in further embodiments, including arranging a plurality of plies to form the first layer.

In addition to one or more of the features described above, or as an alternative, in further embodiments, including partially curing the core prior to placing the core under the compressive or tensile force.

In addition to one or more of the features described above, or as an alternative, in further embodiments, wherein the core is placed under a compressive force to form a composite structure having a concave shape with respect to the first surface or is placed under a tensile force to form a composite structure having a convex shape with respect to the first surface.

In addition to one or more of the features described above, or as an alternative, in further embodiments, wherein heating the core and the first layer partially cures the core and the first layer.

In addition to one or more of the features described above, or as an alternative, in further embodiments, including applying a second layer to a second surface of the core, the second surface opposing the first surface

In addition to one or more of the features described above, or as an alternative, in further embodiments, including applying heat to fully cure the first layer, the core, and the second layer.

In addition to one or more of the features described above, or as an alternative, in further embodiments, wherein placing the core under the compressive or tensile force is followed by clamping the core with a clamping device, and wherein releasing the compressive or tensile force comprises releasing the clamping device.

Another aspect of the disclosure provides a method of forming a composite structure with a contoured shape. A first region of a core is placed under a first compressive or tensile force having a first magnitude and a second region of the core is placed under a second compressive or tensile force having a second magnitude. A first layer is applied to a first surface of the core, a first portion of the first layer residing in the first region of the core and a second portion of the first layer located in the second region of the core. The core and the first layer are heated. The first and second compressive or tensile forces are then released, allowing the composite structure to take a complex shape.

In addition to one or more of the features described above, or as an alternative, in further embodiments, including arranging a plurality of plies to form the first layer.

In addition to one or more of the features described above, or as an alternative, in further embodiments, including partially curing the core prior to placing the core under the compressive or tensile force.

In addition to one or more of the features described above, or as an alternative, in further embodiments, including applying a second layer to a second surface of the core, the second surface opposing the first surface.

### BRIEF DESCRIPTION OF THE DRAWINGS

The following descriptions should not be considered limiting in any way. With reference to the accompanying drawings, like elements are numbered alike:

FIG. 1 is a perspective view of a rotary wing aircraft according to one embodiment;

FIG. 2 is a sectioned side view of a core of a composite structure being formed according to another embodiment; and

FIG. 3 is a sectioned side view of a first layer being applied to a core of a composite structure being formed according to another embodiment; and

FIG. 4 is a sectioned side view of a core and a first layer of a composite structure being formed according to another embodiment; and

FIG. 5 is a sectioned side view of a composite structure formed according to another embodiment; and

FIG. 6A is a sectioned side view of a core and a first layer of a composite structure having a complex contour being formed according to another embodiment; and

FIG. 6B is a sectioned side view of a composite structure having a complex contour that was formed according to another embodiment.

### DETAILED DESCRIPTION

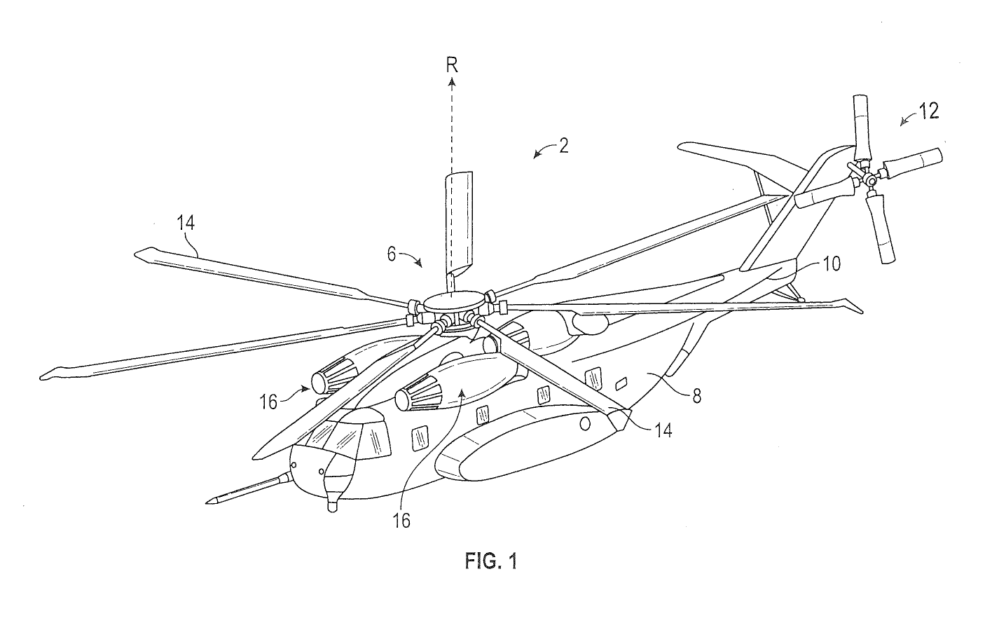

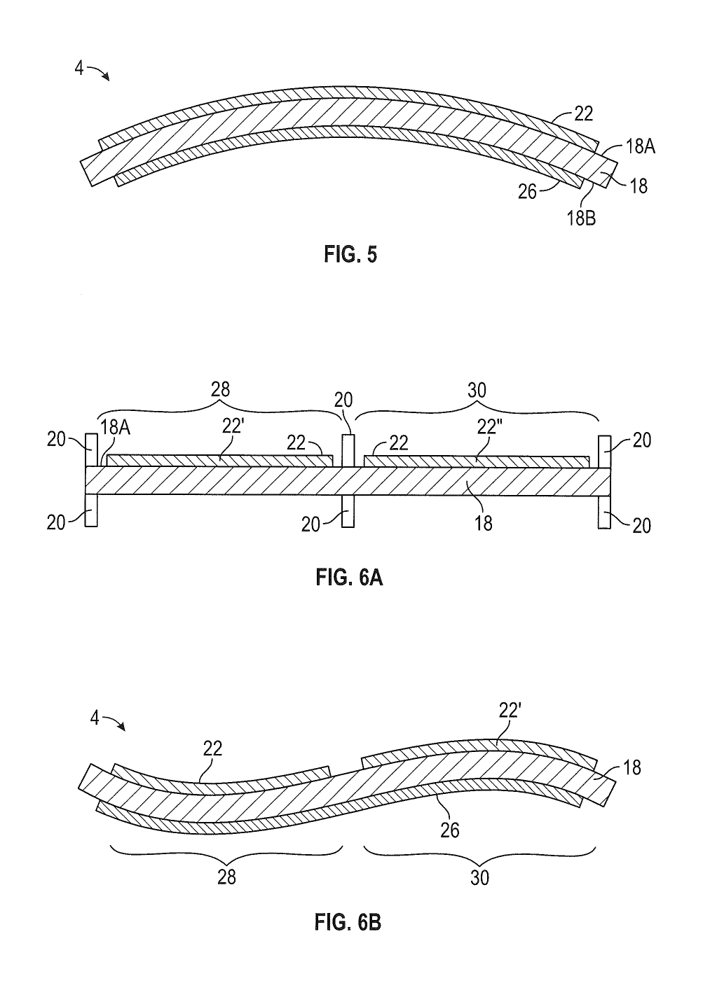

Referring to the figures, FIG. 1 illustrates a rotary-wing aircraft 2 incorporating a composite structure 4 (FIG. 5) according to an embodiment of the invention. While embodiments of the invention are shown and described with reference to a rotary-wing aircraft 2 and are particularly suited to a rotary-wing aircraft 2, aspects of this invention can also be used in other configurations and/or machines such as, for example, automotive applications including commercial and military ground vehicles, building structures, construction applications such as infrastructure, cargo applications, oil and gas industrial applications, shipping applications including containers for rail, marine and aircraft, fixed-wing aircraft applications, non-rotary-aircraft applications, high speed compound rotary wing aircraft with supplemental translational thrust systems, dual contra-rotating, coaxial rotor system aircraft, turbo-props, tilt-rotors and tilt-wing aircraft.

As illustrated in FIG. 1, rotary-wing aircraft 2 has a main rotor system 6 and includes an airframe 8 having an extending tail 10 which mounts a tail rotor system 12, such as an anti-torque system. The main rotor system 6 is shown with a multiple of rotor blades 14 mounted to a rotor hub. The main rotor system 6 is driven about an axis of rotation R through a main gearbox by one or more engines 16. The composite structure 4 of the present disclosure may be incorporated into the aircraft as part of the airframe 8 or any other internal or external part of the aircraft where high strength-to-weight ratios are desired.

The composite structure 4 of the present disclosure may be assembled as a sandwich structure having a multiplicity of layers with a multiple of prepreg plies bonded together and co-cured at the same time through an autoclave process to form a multi-laminate assembly. The composite structure 4 may be manufactured in a single curing process using an autoclave processing but other processing techniques may be utilized.

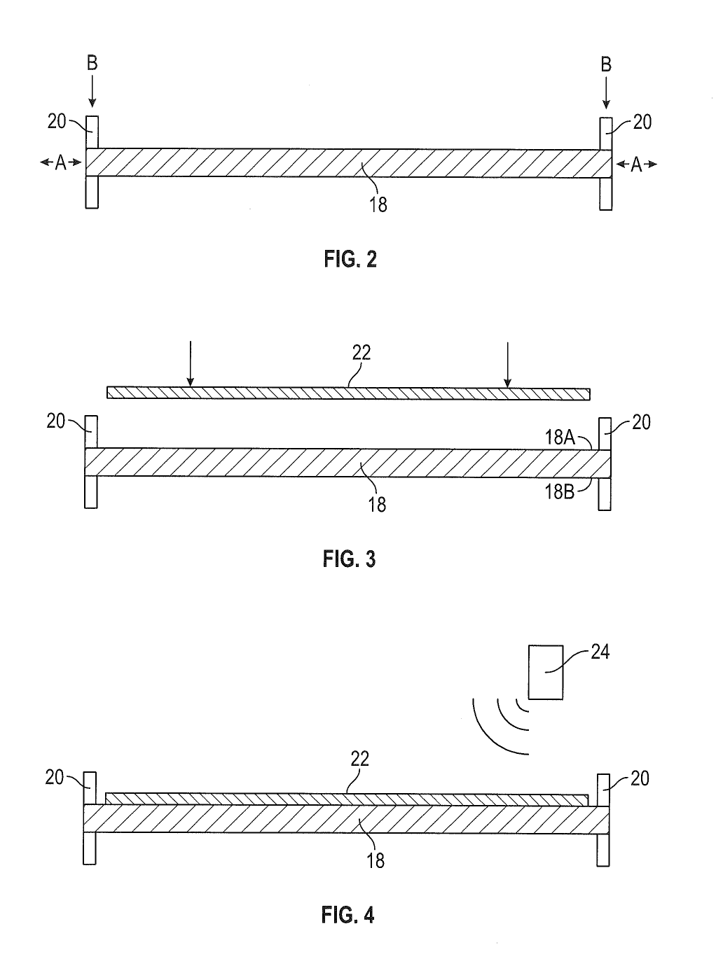

FIGS. 2-5 illustrate a composite structure 4 at various stages of a method for forming the composite structure according to one embodiment of the present disclosure. Referring to FIG. 2, a core 18 is placed in tension or compression (arrows A) in at least one direction. The core 18 may be placed in tension or compression until it reaches a known dimension. For example, the core 18 may be stretched (placed in tension) until it reaches a dimension that is at or near 8% larger than the original dimensions in the direction that the force has been applied. Alternatively, the amount of tensile or compressive force exerted on the core 18 is known. When the desired parameter is reached, (dimension of core, force applied, etc.), the core 18 is held in place by a clamping device 20. The core 18 may be any shape or thickness formed from material suitable for use as a lightweight, high-strength core of a composite structure. For example, the core may be formed from a KEVLAR® honeycomb material having a density of 4.5 pcf or greater.

As shown in FIG. 3, with the core 18 held in tension or compression by the clamping device 20, a first layer 22 is applied to a first surface 18A of the core 18. In the illustrated example, a second surface 18B of the core 18 remains exposed. The first layer 22 may be, for example, a film adhesive. In other examples, the first layer may comprise a plurality of plies that may include prepreg, fiber composites, low-resin films, additional adhesive films, and/or other features known in the art.

Referring to FIG. 4, the first layer 22 and the core 18 are then co-cured by application of heat from a heat source 24. In some examples, the first layer 22 and the core 18 are partially cured. Once the first layer 22 and the core 18 have been cured or partially cured, e.g., for a predetermined amount of time at a predetermined temperature, the core 18 is released from the clamping device 20. Referring to FIG. 5, when the core 18 is placed in tension while the first layer 22 is applied, residual stresses from the forces applied to the core 18 (see FIG. 2) will typically cause the core 18 to bow in a convex direction with respect to the first surface 18A, while a compressed core 18 will typically expand faster than the first layer 22 forming a concave shape at the first surface 18A. If desired, a second layer 26 may then be applied to a second surface 18B of the core 18, opposite the first layer. As with the first layer 22, the second layer 26 may comprise a plurality of plies. For example, the second layer 26 may include anti-saddling strips to prevent the core 18 from losing the desired shape over time. The second layer may 26 then be cured, or co-cured with the partially cured core 18 and first layer 22.

The resulting contoured shape of the sandwich composite structure 4 will vary with the chosen core material and the selection of the first layer 22, and may be affected by the amount of curing. However, where the distribution of stresses throughout the core 18 is homogenous or substantially homogenous, the resulting shape shown in FIG. 5 can be predicted. To improve the homogeneity of the residual stresses in the core 18, the core material may be cured or partially cured prior to the application of the compressive or tensile forces.

The method described herein is useful in the formation of composite structures comprising a core. In particular, the method is useful for forming composite structures where the core is stiff and difficult to place on a mandrel or in a mold. This allows the use of less expensive core materials currently available on the market while reducing the amount of defects and wasted material. In addition, the method of the present disclosure reduces the need for expensive tooling used to place the composite structure in a particular shape.

The method described herein may be used on a composite structure, as described above, or on a portion of a composite structure. For example, where a particular structure comprises a complex curvature, different regions of the core may be placed in tension or compression and clamped into place. FIG. 6A illustrates another embodiment in which a core 18 has a first region 28 and a second region 30. The first region 28 is placed in compression and the second region 30 is placed in tension. The core 18 is then held in placed by clamping devices 20. A first portion 22′ of a first layer 22 is applied in the first region and a second portion 22″ of the first layer 22 is applied in the second region 30. FIG. 6B shows the resulting composite structure 4 after applying heat to cure or partially cure the core 18 and the first layer 22, releasing the clamping devices 20, and applying the second layer 26 and applying additional heat. Note that the curvature of the first region 28 is opposite the direction of the curvature of the second region 30. Other configurations are also possible. The regions of the core 18 may include flat regions. The various regions may be formed with curvatures in the same direction but varying by the extent of the curvature.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc., do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A method of forming a sandwich composite structure, comprising:
placing a core under a compressive force or a tensile force;
applying a first layer to a first surface of the core;
heating the core and the first layer; and
releasing the compressive force or the tensile force.

2. The method of claim 1, wherein placing the core under the compressive or tensile force is performed to reach a known dimension of the core.

3. The method of claim 1, further comprising arranging a plurality of plies to form the first layer.

4. The method of claim 1, further comprising partially curing the core prior to placing the core under the compressive or tensile force.

5. The method of claim 1, wherein the core is placed under a compressive force to form a composite structure having a concave shape with respect to the first surface or is placed under a tensile force to form a composite structure having a convex shape with respect to the first surface.

6. The method of claim 1, wherein heating the core and the first layer partially cures the core and the first layer.

7. The method of claim 1, further comprising applying a second layer to a second surface of the core, the second surface opposing the first surface

8. The method of claim 7, further comprising applying heat to fully cure the first layer, the core, and the second layer.

9. The method of claim 1, wherein placing the core under the compressive or tensile force is followed by clamping the core with a clamping device, and wherein releasing the compressive or tensile force comprises releasing the clamping device.

10. A method of forming a composite structure with a contoured shape, comprising:
placing a first region of a core under a first compressive or tensile force having a first magnitude;
placing a second region of the core under a second compressive or tensile force having a second magnitude;
applying a first layer to a first surface of the core, a first portion of the first layer residing in the first region of the core and a second portion of the first layer located in the second region of the core;
heating the core and the first layer; and
releasing the first and second forces.

11. The method of claim 10, further comprising arranging a plurality of plies to form the first layer.

12. The method of claim 10, further comprising partially curing the core prior to placing the core under the compressive or tensile force.

13. The method of claim 10, further comprising applying a second layer to a second surface of the core, the second surface opposing the first surface.
